(19) United States
(12) Patent Application Publication
(10) Pub. No.: US 2019/0260808 A1
(43) Pub. Date: Aug. 22, 2019

(54) Apparatus and Method for an Inter-Country Telecommunications System

(71) Applicant: Amr Mohamed Elgebaly Saad Elghandour, Cairo (EG)

(72) Inventor: Amr Mohamed Elgebaly Saad Elghandour, Cairo (EG)

(21) Appl. No.: 16/279,938

(22) Filed: Feb. 19, 2019

Related U.S. Application Data
(60) Provisional application No. 62/632,451, filed on Feb. 20, 2018.

(51) Int. Cl. H04L 29/06; H04L 12/24

(52) U.S. Cl. CPC H04L 65/1059; H04L 69/08; H04W 88/06; H04L 63/0428; H04L 41/0809

(57) ABSTRACT

An apparatus and method that converts and transmits cell-network communications (mobile calls and messages) to Voice-over-Internet Protocol (VoIP) calls and messages, and vice versa, for those traveling outside their cell network. The system uses a server that authenticates the electronic device and offers other services; and a device software application. The invention converts and transmits cell-network (e.g., GSM) communications to Voice-over-Internet-Protocol (VoIP) calls and messages and vice versa—converting VOIP calls and messages to cell-network communications.

### FIELD OF THE INVENTION

The present application generally relates to communication or telecommunication, and particularly to a device, system and/or method for supporting roaming for mobile devices such as cell phones, personal digital assistants (PDAs), wireless communication terminals, or any computer-driven device.

### BACKGROUND

Mobile phones use various technologies, including GSM (Global System for Mobile Communication) and UMTS (Universal Mobile Telecommunications System) LTE, which allow users to make calls or send messages over a telecommunication network. GSM and UMTS mobile phones use a Subscriber Identity Module or SIM card. The SIM card is a detachable card contains a user's subscription information and other service information. SIM cards can be removed from devices and placed into other devices, allowing users to change telephone-network companies if they wish.

In the normal course of operation, a mobile phone, through the physical SIM card, can communicate with a home telephone network in a particular country. The communication might be a voice call, text message, or other form of telecommunication. A phone's SIM card establishes connection with a telephone network, through a prepaid or a postpaid communications plan of service provided by a communications provider. When a mobile phone is used in a foreign country, the physical SIM of the home country can establish communication with the foreign telephone network. Carried out in a foreign country, mobile communication of this type is commonly referred to as “roaming,” and it comes at a high cost. Telecommunications companies charge high fees to international travelers who use “roaming” to make calls or text messages.

Telephone network service providers are known to reveal their fee information in obfuscatory language, explaining roaming charges in complex terms of fine print. Current research shows that of the 1.2 billion people who travel abroad each year, about 29 million people use mobile roaming each month. According to a study conducted by Juniper Research, in 2013 telecommunication companies made $57 billion and about 64% of that revenue was made just by voice roaming fees alone. These fees are expected to increase in coming years, with estimates of $90 billion in roaming fees in 2018.

Eighty-eight percent of Roamers pay more than $100/month in roaming fees. Despite the widespread use of VoIP apps and online messaging, these individuals still use choose the convenience of using their original cell phones/numbers abroad and continue incurring the roaming fees.

Businesses also lose money by reimbursing their employees for roaming fees. A 2012 CCMI (https://www.ccmi.com/) survey revealed that more than a third of Fortune-1000 companies spend over $1,000 per month on roaming charges per each employee sent abroad.

Roaming fees can be mitigated by purchasing local phones (with local service providers) or by purchasing local SIM cards while traveling. However in addition to the inconvenience of carrying multiple phones, calling home from a foreign country using a foreign telephone network may still be expensive (although not as high as roaming fees). Another drawback is having to use a separate phone number. For frequent travelers, getting a new phone number for each trip in each country is prohibitively inconvenient and expensive in both time and money.

Another common alternative to roaming is to use free Voice-over-Internet-Protocol (VoIP) apps (e.g., FaceTime and WhatsApp) which do not incur fees as long as both users have the app on their phones. Even with free calling and messaging offered by these apps, users still choose to make calls with their cell phones (and their own phone numbers) while abroad. Switching to new phones and phone numbers to do business abroad causes confusion and logistical inconveniences with clients. Porting or looking up contact information that was stored in a user's original phone; informing business colleagues, partners and clients of their new foreign phone number; and keeping track of these changes are prohibitive inconveniences. In addition, corporations that require cell-network communication with their employees also are reluctant to switch providers and phones each time an employee travels.

A useful alternative to the cost and inconvenience of cellular telecommunications would be a device, system and method that supports mobile-device use across countries and skirts the roaming fees involved with cellular networks.

“Mobile devices” in the context of this invention are understood to include any type of electronic communications device that uses cellular network communications technology.

### SUMMARY

This invention is an apparatus and method for an inter-country telecommunications system which converts cellular-network communications to VOIP communications with the aim of avoiding roaming fees associated with out-of-network cell-phone use. The apparatus is equipped with a slot which receives and reads a cell phone's SIM card. An Ethernet port connects the apparatus to a wired Internet connection. The apparatus's resident computer application receives communications from the sending party through VOIP; translates the VOIP communications to cellular-network communications; and sends the translated communication through the wired Internet connection through the cellular network to the receiving party. The receiving party experiences the call as a cellular-network call. In turn, outbound communications from the receiving party are received by the apparatus through the cellular network, translated into VOIP communications, and sent back to the original caller. The apparatus and method allow users to communicate without incurring roaming charges associated with cellular-network communications.

### BRIEF DESCRIPTION OF THE DRAWINGS

FIG. 1 shows an apparatus and method for an inter-country telecommunications system.

FIGS. 2A-2C show an iteration of the embodiment.

FIGS. 3A-3B show another iteration of the embodiment.

FIGS. 4-5 show a method for converting and transmitting cell-network communications to Voice-over-Internet-Protocol (VoIP) messages and vice versa—converting VOIP communications to cell-network communications.

### DETAILED DESCRIPTION

The following detailed description is intended to illustrate but not define the limits of the invention.

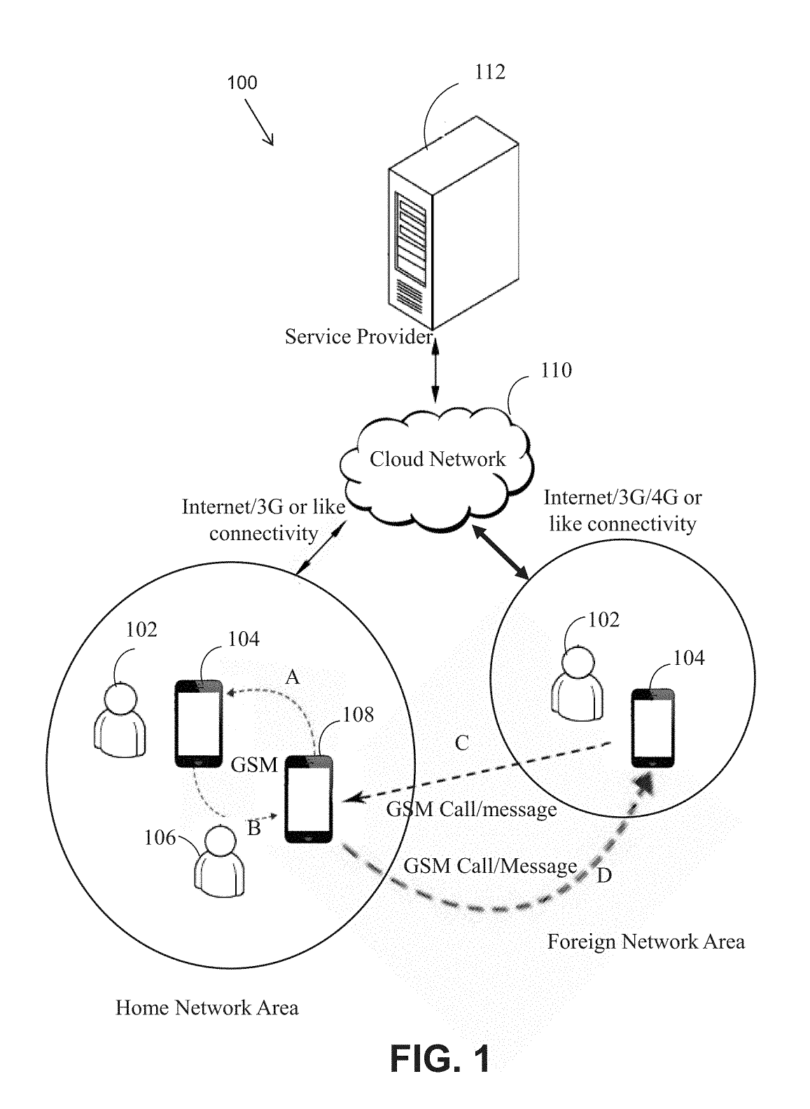

FIG. 1 shows a system for supporting roaming for mobile devices. A system 100 includes users 102 and 106 belonging to a common home network in a user's home country. The home network area may be any conventional mobile network area, for example GSM. Mobile-phone users 102 and 106 of the home network are associated with mobile devices 104 and 108 respectively. In the context of the present invention, the mobile phone 104 of the user 102 has Internet connectivity capability, whereas the mobile phone 108 of the user 106 may or may not have Internet connectivity.

The system 100 includes a service provider 112 that provides a telecommunications apparatus and method to users 102.

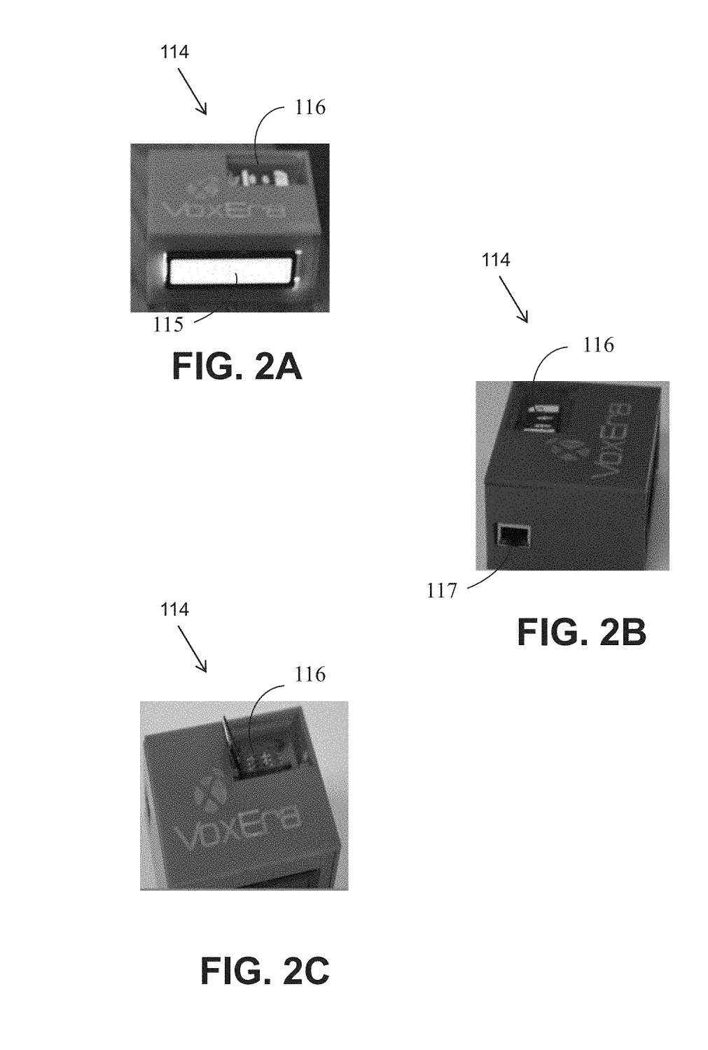

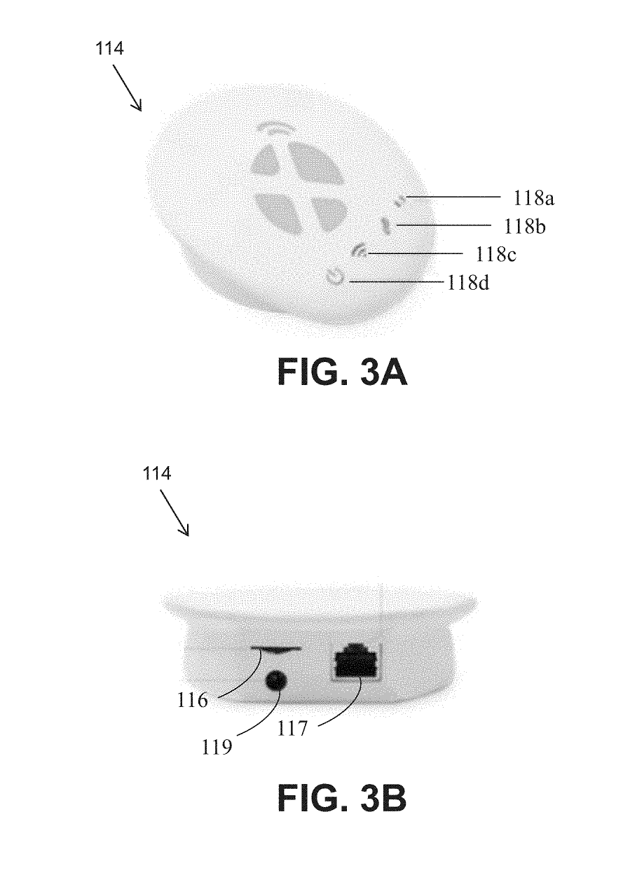

The service provider 112 makes available an electronic device 114 (FIGS. 2A, 2B and 2C and FIGS. 3A and 3B) that is capable of converting and transmitting cell-network communications to Voice-over-Internet-Protocol (VoIP) communications, and vice versa.

FIGS. 2A, 2B and 2C show the electronic apparatus 114 with a display 115 that indicates connection status, network status, strength of WiFi signal, and IP address. A SIM card may be inserted into the SIM card slot 116. A power connection is not seen. An Ethernet port 117, FIG. 2B allows wired connection to the Internet. (This Ethernet port is on the back of the apparatus and is not seen in FIGS. 2A and 2C.)

Internally, the electronic device 114 uses one or more processors (e.g., an ARM processor) running on an operating system (such as Linux); GSM/3G/4G modules; and encryption modules (e.g. VPN, SSL and https).

Another iteration of the device 114 shown in FIG. 3A-3B, houses a plurality of indicators 118a, 118b, 118c, 118d showing information about mobile network status, connection status, WiFi status and power status, instead of displaying such information on the display 115 as discussed in the context of FIG. 2A-2C.

According to various embodiments of the present invention, the device 114 may be embodied with various capabilities. For example: The device 114 may have support for internet throw cable or WiFi and may support a single SIM card. The device 114 may have 3G/4G support with internet throw cable or WiFi or 3G/4G and may support a single SIM card. The device 114 may have support for internet through cable or WiFi with support for 2 SIM cards. The device 114 may have support for 3G/4G with internet through cable or WiFi or 3G/4G with support for 2 SIM cards. The device 114 may have support for internet through cable, WiFi or 3G/4G with support for 4 SIM cards. The device 114 may have support for internet through cable, WiFi or 3G/4G with support for 8 SIM cards. The device 114 may have support for internet through cable, WiFi or 3G/4G with support for 12 SIM cards. The device 114 may have support for internet through cable, WiFi or 3G/4G with support for 16 SIM cards.

A service provider 112 also makes available a software application that can be configured onto user's mobile phone 104. The software application enables the users 102 to connect with another user 106 present on the home network, when the users 102 is roaming, or out of home network. The application software is configurable on the user device 102 when the user 102 is in the foreign network area over an internet connection (Wifi or 3G/4G connection or like connections).

In normal course of operation, when the users 102 and 106 have to communicate with each other within the home network, the users 102 and 106 make cell-network communications calls or share messages over the mobile network (Eg. GSM calls or messages), as indicated by arrows ‘A’ and ‘B’. This is possible by using a SIM card that can be detachably inserted inside the mobile phones 104 and 108. The SIM cards contain the user's subscription information and other service information and helps users 102 and 106 to communicate using the mobile network (Eg. GSM). The users 102 and 106 within the same home network are able to make calls or exchange messages at a very minimal rates or plans offered by the mobile network operators. When the user 102 travels out of home network i.e. abroad, then the user 102 is able to make calls or send messages to the user 106 and receive the calls and messages from the user 106 making use of the home network and the foreign network, as indicated by arrow ‘C’ and ‘D’. But since the user 102 is only able to do so with the help of the foreign network's connectivity, that connects the user 102 in the foreign network to the user 106 in the home network, the cost per call or cost for messages over the mobile network is quite high. Although, the user 102 is able to make calls or exchange messages with the user 106, the user 102 is billed for roaming by his operator and that usually costs much higher compared to the usual normal call or messaging rates the user 102 would have paid making local calls within home network, while the user 102 was not traveling. The proposed invention is devised to mitigate these high roaming costs.

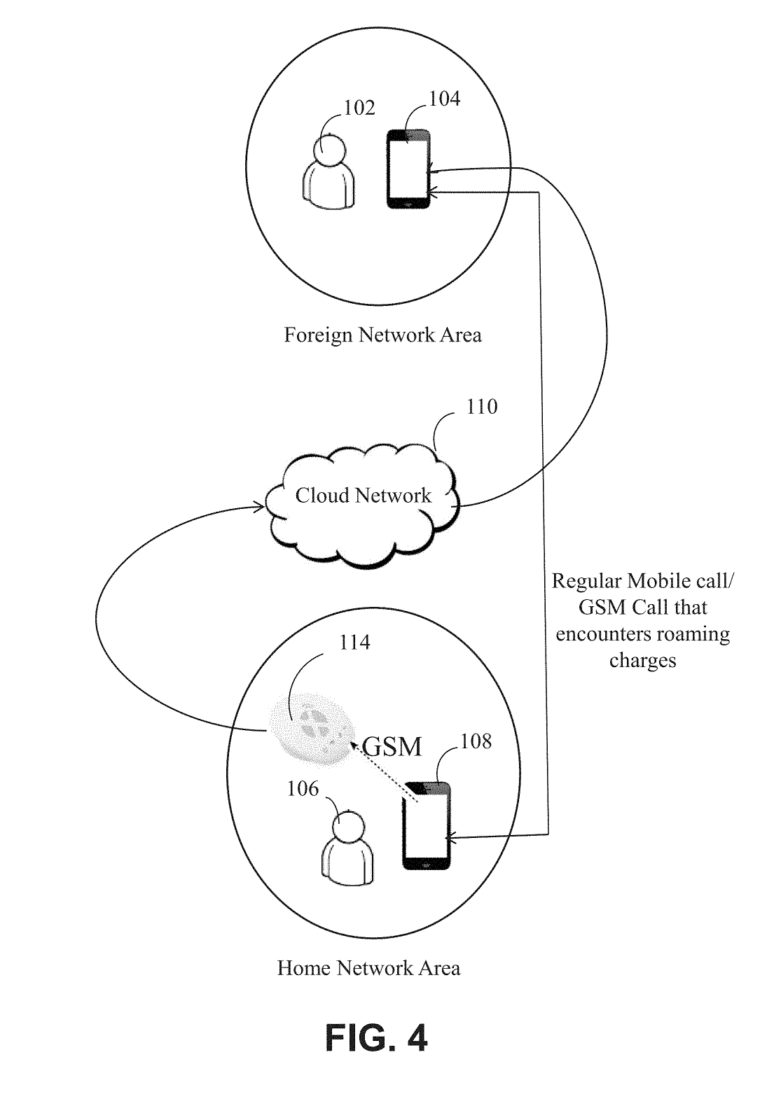

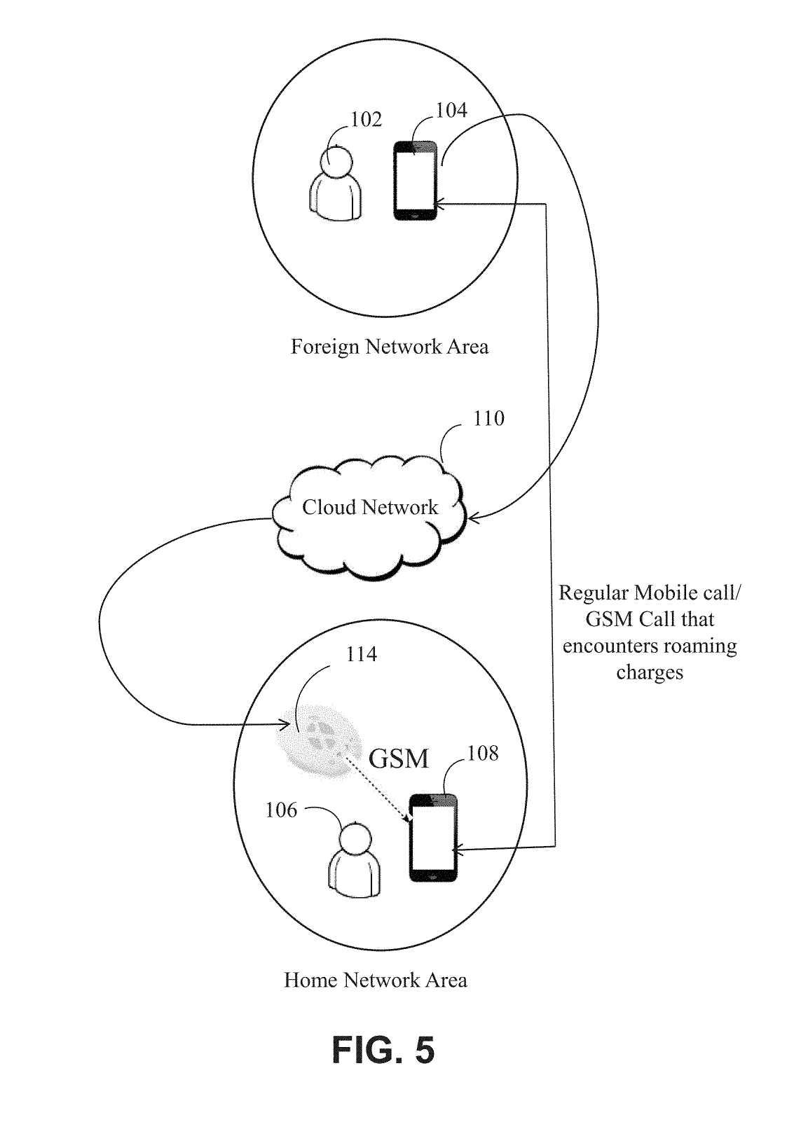

FIG. 4-5 illustrates a detailed methodology for converting and transmitting cell-network communications calls and messages to Voice over Internet Protocol (VoIP) call or messages and/or vice versa, according to an embodiment of the present invention. In order to understand the methodology in the context of present invention, the user 102 is firstly required to place his local SIM card (related to the home network) in the SIM card slot of the electronic device 114 and leave it within the home network area in his home country (For example, the user 102 can leave the SIM at home while the device 114 is actively running at his home). The device 114 is then powered up and is connected to internet throw cable or to WiFi. The user 102 then pushes the setup button to boot the electronic device 114. The user 102 then registers his account and adds the device 114 with the service provider 112 (via service provider's website for example). When the user 102 adds the device 114, the user 102 is required to enter authentication credentials identifying the device 114. The authentication credentials preferably include but not limited to IMEI number or any other serial number or codes that may identify the device 114. Once the device 114 is added, the service provider 112 automatically creates username, password and/or IP address for the device 114. The device 114 gets configured onto the server 112 hosted by the service provider. Once successfully configured, the device 114 is able to download PRX and various module drivers from the server 112 required for its functioning.

Once the device 114 is configured, the user 102 can then move abroad without any fear of roaming charges from the phone network operator. When in the foreign network areas, the user 102 is simply required to download and install the software application provided by the service provider 112 using WiFi or 3G/4G network. Once the application is configured onto the mobile phone 104 of the user 102, the user 102 is required to login using login credentials, such as username and password in order to be able to make calls or share messages with the user 106 present in the home network. The mobile application and the device 114 (left behind by the user 102) interconnect and build a virtual path for the calls/messages sent by the user 102 to the user 106. Referring to FIG. 5, when the user 102 is abroad and makes a call or sends a message through the application configured on his phone 104, the application receives and transmits the call/message as VoIP, and the VoIP call/message is routed to the electronic device 114 through the cloud network 110. The electronic device 114 then receives the VoIP call/message and converts it to the GSM call/message and forward to the user 106 present in the home network. In this working, the call/message, from the user 102 to the user 106 undergoes as if the calls/messages are made within the home network without involving any foreign network service provider and the user 102 is simply charged local call rates which is far less compared to the roaming rates.

Further, referring to FIG. 4, when the user 106 present in the home network area makes a call or sends a message to the user 102 present in the foreign network area, the GSM call/message from the user 106 is converted into VoIP call/message and transmitted over to the cloud network 110 using internet connectivity by the electronic device 114. When the VoIP call/message arrives to the user 102, the user 102 receives the VoIP call/message over the application configured on his mobile 104 using internet (WiFi or any 3G/4G data). In this case, the call/message from the user 106 is a cell-network communication for users 106 and 102, as the user 106 is present within his home network and just uses his phone 108 with local SIM card to make a call, without use of any application. Thus, there is no involvement of any foreign network service provider for establishing communication between the users 102 and 106 eliminating any need for the roaming services provided by the mobile network operators.

The above described system and method works on the principle that the users 102 and 106 are within the same home network all the time, despite the user 102 is abroad thereby always keeping the roaming charges equal to local call charges.

The proposed invention in its application is suitable for frequent travelers, businesses who care about their customers and reputation; companies that always need to be connected with their employees.

Although, it is not described in an explicit manner, but it should be understood that the mobile devices include several hardware and software components such as one or more processor modules, one or more memories, transceivers, one or more program routines or sub routines, that may assist in downloading and installation of the software application and help in executing the application. Further, it should be well understood that the software application will essentially support android/IOS/Windows phone/web phone.

It will finally be understood that the disclosed embodiments are presently preferred examples of how to make and use the claimed invention, and are intended to be explanatory rather than limiting of the scope of the invention. Reasonable variations and modifications of the illustrated examples in the foregoing written specification and drawings are possible without departing from the scope of the invention. It should further be understood that to the extent the term “invention” is used in the written specification, it is not to be construed as a limited term as to a number of disclosed inventions or the scope of any such invention, but as a term which has long been conveniently and widely used to describe new and useful improvements in technology.

1. An apparatus for two-way conversion between cell network protocol communications and voice-over-internet-protocol communications comprising:
a display for showing connection status, network status, WiFi signal strength and Internet Protocol address; and
at least one SIM card slot for receiving at least one SIM card; and
an Ethernet port for connecting to a wired internet connection; and
providing a sending caller and a receiving caller; and
a processor for non-transitory computer-readable medium storing instructions; and
said instructions running encryption modules; wherein
encrypted voice-over-internet-protocol communications from a sending caller are received in the apparatus through said wired internet connection and through said Ethernet port; said communications are decrypted and sent to a receiving caller through a cell network protocol according to said SIM card; and the reverse of the process occurs from said receiving caller to said sending caller.

2. The apparatus of claim 1 wherein at least sixteen SIM card slots receive at lest sixteen SIM cards.

3. The apparatus of claim 1 wherein a user profile is configured on a server; and
upon connection of the apparatus to said Ethernet, the apparatus connects with said user profile; and
information from said user profile is downloaded into the apparatus; and
the apparatus is configured according to said information from said user profile.

4. An apparatus for two-way conversion between cell network protocol communications and voice-over-internet-protocol communications comprising:
at least four illuminated icons for showing connection status, network status, WiFi signal strength and Internet Protocol address; and
at least one SIM card slot for receiving at least one SIM card; and
an Ethernet port for connecting to a wired internet connection; and
providing a sending caller and a receiving caller; and
a processor for non-transitory computer-readable medium storing instructions; and
said instructions running encryption/decryption modules; wherein
encrypted voice-over-internet-protocol communications from a sending caller are received in the apparatus through said wired internet connection and through said Ethernet port; said communications are decrypted and sent to a receiving caller through a cell network protocol according to information contained on said SIM card; and communications from said receiving caller are received through said cell network protocol, are then encrypted and sent over voice-over-internet-protocol to said sending caller.

5. A method for sending and receiving calls the method comprising:
sending communications from a sending caller, through a voice-over-internet-protocol; and
receiving said communications to an apparatus for translating between voice-over-internet-protocol and cell network protocol; and
translating said voice-over-internet-protocol communication to cell network protocol; and
sending translated communications through cell network protocol to a receiving caller; and
sending communications from said receiving caller to the apparatus through said cell network protocol; and
receiving communications from said receiving caller through cell network protocol; and
translating communications received from said receiving caller to voice-over-internet-protocol communications; and
sending translated communications from said receiving caller to said sending caller through voice-over-internet-protocol.

6. A method for sending and receiving calls the method comprising:
setting up a user profile on a server; and
connecting an apparatus to the Ethernet; and
inserting a SIM card; and
sending communications from a sending caller, through a voice-over-internet-protocol; and
receiving said communications to an apparatus for translating between voice-over-internet-protocol and cell network protocol; and
translating said voice-over-internet-protocol communication to cell network protocol; and
sending translated communications through cell network protocol to a receiving caller; and
sending communications from said receiving caller to the apparatus through said cell network protocol; and
receiving communications from said receiving caller through cell network protocol; and
translating communications received from said receiving caller to voice-over-internet-protocol communications; and
sending translated communications from said receiving caller to said sending caller through voice-over-internet-protocol; wherein
said apparatus receiving information from said SIM card and downloading information from said user profile through said Ethernet connection, configures the apparatus.
